(19) United States
(12) Patent Application Publication
(10) Pub. No.: US 2025/0256670 A1
(43) Pub. Date: Aug. 14, 2025

(54) FRONT STRUCTURE OF VEHICLE

(71) Applicant: TOYODA GOSEI CO., LTD., Kiyosu-shi (JP)

(72) Inventors: Takaki ITATSU, Aichi (JP); Koichi SUZUKI, Aichi (JP); Tomohiro KAJITANI, Aichi (JP); Masashi OTOYO, Aichi (JP); Hiroshi TAKAKURA, Aichi (JP)

(21) Appl. No.: 19/045,632

(22) Filed: Feb. 5, 2025

(30) Foreign Application Priority Data
Feb. 9, 2024 (JP) 2024-018681

(51) Int. Cl. B60R 19/18

(52) U.S. Cl. CPC B60R 19/18; B60R 2019/1853

(57) ABSTRACT

A front structure constitutes a front portion of a vehicle body and has a main body including a pair of side portions, an upper portion, and a pair of stay portions. The side portions are provided at an interval in a width direction, and extend in an upper-lower direction. The upper portion extends in the width direction, and couples end portions on an upper side of the side portions. The stay portions extend from respective end portions on a lower side of the side portions in respective directions intersecting both the width direction and the upper-lower direction, and are connected to the upper portion. An end edge on the lower side of the stay portions constitutes a part of an outer peripheral edge of the front structure. The side portions, the upper portion, and the stay portions have an uneven portion extending along directions in which these portions extend.

### CROSS-REFERENCE TO RELATED APPLICATIONS

This application is based on and claims priority under 35 USC 119 from Japanese Patent Application No. 2024-018681 filed on Feb. 9, 2024, the entire content of which is incorporated herein by reference.

### TECHNICAL FIELD

The present disclosure relates to a front structure of a vehicle.

### BACKGROUND ART

WO2012/153601A1 describes a front structure of a vehicle body that is arranged on a front surface side of a radiator to support the radiator, that is, a so-called radiator support. The front structure of a vehicle body includes an upper extending in a vehicle width direction and a lower extending in the vehicle width direction below the upper. A pair of sides extending in an upper-lower direction of the vehicle body are each coupled to an end of the upper and an end of the lower in the vehicle width direction.

The upper is provided with, for example, a locking structure portion of a hood that opens and closes an engine room of a vehicle.

The radiator is attached to the pair of sides.

The front structure of a vehicle body further includes a center stay that extends in the upper-lower direction and couples the upper and the lower, and a pair of side stays that extend in directions intersecting both the vehicle width direction and the upper-lower direction and couple the upper and the sides.

The front structure of a vehicle body is integrally molded from a fiber reinforced resin. Accordingly, a strength desired for the radiator support is ensured.

According to such a front structure of a vehicle body, a strength of the front structure of a vehicle body, particularly the upper, in the upper-lower direction is increased by the center stay and the pair of side stays. Accordingly, it is possible to provide the front structure of a vehicle body with a strength that can withstand a strong load acting in the upper-lower direction when the hood is closed, for example.

However, such a front structure has a problem that a structure is complicated due to the provision of the center stay and the side stays. Therefore, it is desired to increase the strength of the front structure with a simple configuration.

### SUMMARY OF INVENTION

An aspect of the present disclosure will be described.

(1) The aspect of the present disclosure provides a front structure of a vehicle, which is made of a fiber reinforced resin and integrally molded by injection molding,
the front structure constituting a part of a front portion of a vehicle body of the vehicle, and having a main body portion that includes:
when a width direction and an upper-lower direction of the vehicle are referred to as a vehicle width direction and an upper-lower direction, and an upper side and a lower side in the upper-lower direction are simply referred to as an upper side and a lower side,
   a pair of side portions that are provided at an interval in the vehicle width direction, and extend in the upper-lower direction;
   an upper portion that extends in the vehicle width direction, and couples end portions on the upper side of the pair of side portions; and
   a pair of stay portions that extend from respective end portions on the lower side of the pair of side portions in respective directions intersecting both the vehicle width direction and the upper-lower direction, and are connected to the upper portion,
in which an end edge on the lower side of the pair of stay portions constitutes a part of an outer peripheral edge of the front structure, and
at least one of the side portions, the upper portion, or the stay portions has an uneven portion extending along a direction in which the portion extends.

When the front structure is integrally molded by the injection molding, a fountain flow phenomenon, in which the molten resin bubbles up and flows toward the molding surface sides of a mold, occurs at a front end portion in a flow direction of a molten resin flowing in a cavity of the mold. Therefore, fibers in the molten resin move along a surface of the above-described front end portion and flow toward the molding surface sides of the mold. Accordingly, in skin layers on the molding surface sides that are formed by cooling and solidifying the molten resin filled in the cavity earlier than a central portion (a core layer) of the molten resin filled in the cavity, orientations of the fibers are easily aligned in the flow direction. Since a strength of the fiber reinforced resin is increased in the direction in which the orientations of the fibers are aligned, a strength of the front structure is increased by the above-described skin layers.

Here, according to the above-described configuration, a surface area of the main body portion of the front structure is increased by the uneven portion. Accordingly, an area of the skin layers is increased. As a result, the strength of the front structure can be further increased.

Further, according to the above-described configuration, the end edge on the lower side of the pair of stay portions constitutes a part of the outer peripheral edge of the front structure. In other words, the front structure does not include the lower portion, described in WO2012/153601A1, which couples the end portions on the lower side of the pair of side portions and extends in the vehicle width direction. Even in this case, if the uneven portion is formed on the main body portion, the strength of the front structure is increased by the above-described operations, and therefore, the front structure has a sufficient strength to serve as a component constituting a part of the front portion of the vehicle body.

Therefore, the strength can be increased with a simple configuration.

(2) In the front structure of the aspect, the uneven portion is provided continuously over all of the pair of side portions, the upper portion, and the pair of stay portions.

According to the above-described configuration, the area of the skin layers can be increased over the entire main body portion. Therefore, the strength of the front structure can be further increased.

(3) In the front structure of the aspect, when a front-rear direction of the vehicle is referred to as a front-rear direction, and a front side and a rear side in the front-rear direction are simply referred to as a front side and a rear side,
the main body portion includes:
   a pair of side wall portions that extend in the front-rear direction, and are arranged at an interval from each other; and
   a bottom wall portion that couples end portions on the rear side of the pair of side wall portions,
the uneven portion is a ridge portion provided on the bottom wall portion and protruding toward the front side, and
a groove portion is provided on a rear surface of the bottom wall portion, the groove portion extending along the ridge portion and opening to the rear side.

According to the above-described configuration, a size of the front structure in the front-rear direction can be reduced as compared with a case in which the uneven portion is a ridge portion that protrudes towards the rear side from the bottom wall portion of the main body portion.

(4) In the front structure of the aspect, a restricting portion is provided on the rear surface of the bottom wall portion, the restricting portion extending in a direction intersecting a direction in which the groove portion extends and facing a bottom surface of the groove portion.

According to the above-described configuration, a part of an elongated member such as a wire harness, a washer hose, or a hood lock wire routed in the front portion of the vehicle can be accommodated in the groove portion. Further, since the elongated member is surrounded in the groove portion made of a resin, a protective material such as a corrugated metal that protects the elongated member can be eliminated.

According to the above-described configuration, the restricting portion, which faces the bottom surface of the groove portion, is provided on the rear surface of the bottom wall portion. Therefore, the elongated member accommodated in the groove portion is restricted from moving toward the rear side from the groove portion. Therefore, the elongated member can be prevented from falling off from the groove portion.

(5) In the front structure of the aspect, a gate mark is formed on the main body portion, the gate mark being a mark of a gate used when the front structure is injection-molded, and
the gate mark is formed on a portion different from the uneven portion.

When the front structure is integrally molded by the injection molding, since the flow direction of the molten resin flowing in the cavity is not fixed to one direction near the gate, the orientations of the fibers in the skin layers are difficult to be aligned in the same direction. Therefore, when the gate mark is formed on the uneven portion, it is difficult to increase the strength by the uneven portion.

In this regard, according to the above-described configuration, the gate mark is formed on a portion of the main body portion different from the uneven portion. Therefore, a strength of the main body portion can be suitably increased by the uneven portion.

(6) In the front structure of the aspect, the main body portion has a shape being symmetrical with respect to a virtual plane that passes through a central portion of the upper portion in the vehicle width direction and is orthogonal to the vehicle width direction, and
the gate mark is located at the central portion.

According to such a configuration, when the front structure is integrally molded by the injection molding, the cavity is filled with the molten resin from the gate located at the central portion. Here, the main body portion of the front structure has a shape that is symmetrical with respect to the virtual plane. Therefore, the molten resin in the cavity easily flows along a certain flow direction, such as flowing outward in the vehicle width direction from the central portion in the cavity for molding the upper portion and then flowing into the cavity for molding the side portion and the stay portion. Accordingly, in the skin layers, the orientations of the fibers are easily aligned in the above-described flow direction. Therefore, the strength of the front structure can be further increased.

(7) In the front structure of the aspect, the uneven portion is provided on the upper portion and the pair of stay portions,
the main body portion has a weld portion formed by molten resins colliding with each other when the front structure is integrally molded by the injection molding, and
the weld portion is formed only on the side portion.

Since the upper portion and the pair of stay portions each have a component extending in the vehicle width direction, a load in the vehicle width direction is likely to act on the upper portion and the pair of stay portions when the vehicle body is twisted during turning or the like of the vehicle. Therefore, the upper portion and the stay portions are each required to have a strength capable of withstanding the above-described load.

Meanwhile, when the front structure is integrally molded by the injection molding, the weld portions are formed on the front structure by the molten resins branched in the cavity colliding with each other. In the weld portions, orientation directions of the fibers are changed by changing the flow direction due to the collision. Therefore, the fibers are oriented in a direction intersecting the flow direction of the molten resin flowing in the cavity. Accordingly, a strength of each of the weld portions is likely to be lower than that of other portions.

In this regard, according to the above-described configuration, the weld portions are formed only on the respective side portions. Therefore, the strength of each of the upper portion and the pair of stay portions is not reduced by the weld portions. Further, since the uneven portion is formed on the upper portion and the pair of stay portions, the strength of each of the upper portion and the pair of stay portions is increased by the uneven portion.

Therefore, the strength of the front structure can be further increased.

According to the aspects of the present disclosure, the strength can be increased with a simple configuration.

### BRIEF DESCRIPTION OF DRAWINGS

Exemplary embodiment(s) of the present invention will be described in detail based on the following figures, wherein:

FIG. 1 is a perspective view illustrating a front portion of a vehicle equipped with a front structure according to an embodiment;

FIG. 2 is a rear view illustrating the front structure in FIG. 1;

FIG. 3 is a cross-sectional view taken along a line 3-3 in FIG. 2;

FIG. 4 is a schematic view illustrating orientations of fibers in skin layers and a core layer; and

FIG. 5 is a schematic view illustrating orientations of fibers in a skin layer including a weld portion.

### DESCRIPTION OF EMBODIMENTS

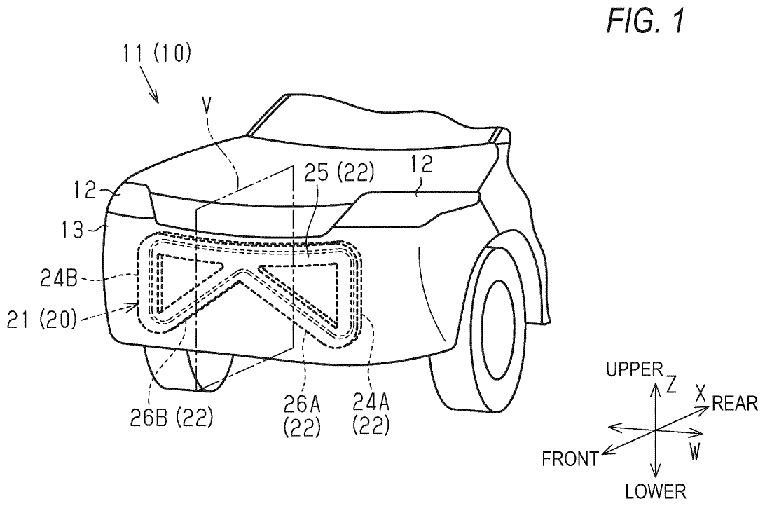

Hereinafter, an embodiment of a front structure of a vehicle will be described with reference to FIGS. 1 to 5. In the present embodiment, the present invention is embodied as a front structure 22 of an automobile 10.

Hereinafter, a front-rear direction of the automobile 10 is referred to as a front-rear direction X, and a front side and a rear side in the front-rear direction X are simply referred to as a front side and a rear side. Further, a vehicle width direction of the automobile 10 is described as a vehicle width direction W. In addition, an upper-lower direction of the automobile 10 at the time when the automobile 10 is located on a horizontal plane is referred to as an upper-lower direction Z, and an upper side and a lower side in the upper-lower direction Z are simply referred to as an upper side and a lower side.

### Front Structure 22

As illustrated in FIG. 1, a front portion 11 of the automobile 10 is provided with an exterior member 13 integrally constituting an outer shell of a portion of the front portion 11 below a pair of headlights 12.

A front structure 22, which is attached to front ends of a pair of front side members (not illustrated) of a vehicle body 20 and constitutes a part of a front portion 21 of the vehicle body 20, is provided on a rear side of the exterior member 13.

The front structure 22 is made of a fiber reinforced resin and is integrally molded by injection molding. As the fiber reinforced resin, for example, a glass fiber reinforced resin obtained by mixing a glass fiber in a polyethylene resin can be used.

### (Main Body Portion 23)

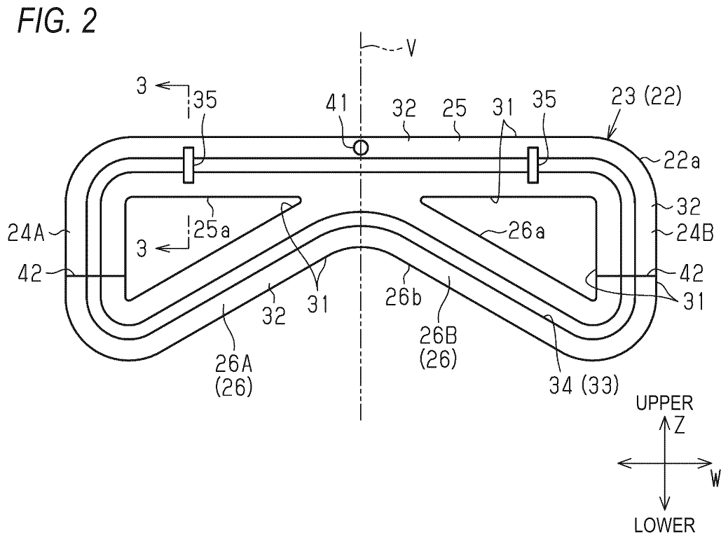

As illustrated in FIG. 2, the front structure 22 includes a main body portion 23 including a pair of side portions 24A and 24B, an upper portion 25, and a pair of stay portions 26A and 26B.

The pair of side portions 24A and 24B are portions that are provided at an interval in the vehicle width direction W and extend in the upper-lower direction Z.

The upper portion 25 is a portion that extends in the vehicle width direction W and couples end portions on the upper side of the pair of side portions 24A and 24B.

The stay portion 26A is a portion that extends from an end portion on the lower side of the side portion 24A in a direction intersecting both the vehicle width direction W and the upper-lower direction Z and is connected to the upper portion 25.

The stay portion 26B is a portion that extends from an end portion on the lower side of the side portion 24B in a direction intersecting both the vehicle width direction W and the upper-lower direction Z and is connected to the upper portion 25.

The pair of stay portions 26A and 26B, as a whole, constitute an arch portion 26 that extends in a curved shape such that a central portion in the vehicle width direction W protrudes toward the upper side.

An end edge 26a on the upper side of the arch portion 26 is connected to an end edge 25a on the lower side of the upper portion 25 at a central portion of the upper portion 25 in the vehicle width direction W.

An end edge 26b on the lower side of the arch portion 26 constitutes a part of an outer peripheral edge 22a of the front structure 22.

The main body portion 23 has a shape that is symmetrical with respect to a virtual plane V that passes through the central portion of the upper portion 25 in the vehicle width direction W and is orthogonal to the vehicle width direction W.

### (Side Wall Portion 31 and Bottom Wall Portion 32)

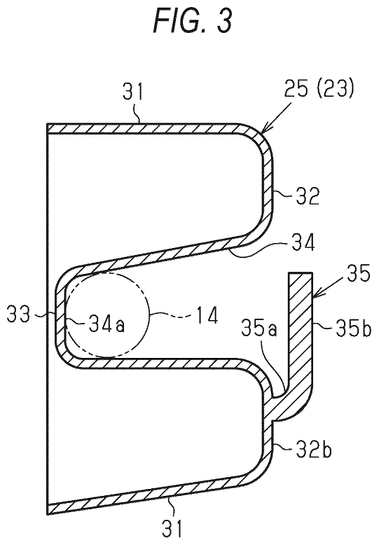

As illustrated in FIGS. 2 and 3, the main body portion 23 includes a pair of side wall portions 31 and a bottom wall portion 32.

The pair of side wall portions 31 extend in the front-rear direction X and are arranged at an interval from each other in a direction orthogonal to both the front-rear direction X and an extending direction in which the portions 24A, 24B, 25, and 26 of the main body portion 23 extend (see FIG. 2).

The bottom wall portion 32 couples end portions on the rear side of the pair of side wall portions 31 (see FIG. 3).

A ridge portion 33, which protrudes toward the front side, is formed on the bottom wall portion 32. A groove portion 34, which opens to the rear side, is formed on a rear surface 32b of the bottom wall portion 32. The groove portion 34 is a portion that is formed inextricably with the ridge portion 33.

As illustrated in FIG. 2, the ridge portion 33 extends along the extending direction in which the portions 24A, 24B, 25, and 26 of the main body portion 23 extend. The ridge portion 33 is formed continuously over all of the portions 24A, 24B, 25, and 26 of the main body portion 23, that is, over the entire main body portion 23.

The groove portion 34 is configured such that a part of an elongated member routed in the front portion 11 of the automobile 10 can be accommodated therein. FIG. 3 illustrates, by a two-dot chain line, a wire harness 14 as an example of the elongated member. Examples of the elongated member include a washer hose and a hood lock wire in addition to the wire harness.

As illustrated in FIGS. 2 and 3, restricting portions 35 are provided on the rear surface 32b of the bottom wall portion 32. In the present embodiment, the pair of restricting portions 35 are provided on the upper portion 25 at an interval in the vehicle width direction W (see FIG. 2).

As illustrated in FIG. 3, the restricting portions 35 each include a base end portion 35a protruding towards the rear side from the rear surface 32b, and a facing wall portion 35b extending from the base end portion 35a in a direction (in the present embodiment, the upper-lower direction Z) intersecting an extending direction in which the groove portion 34 extends. The facing wall portion 35b faces a bottom surface 34a of the groove portion 34 in the front-rear direction X.

### (Gate Mark 41 and Weld Portion 42)

As illustrated in FIG. 2, the main body portion 23 has a gate mark 41 that is a mark of a gate used when the front structure 22 is injection-molded, and weld portions 42 that is formed by molten resins colliding with each other.

The gate mark 41 is located at a central portion in the vehicle width direction W of the bottom wall portion 32 of the upper portion 25. The gate mark 41 is formed on a portion different from the ridge portion 33.

In the present embodiment, each of the weld portions 42 is formed only on a respective one of the pair of side portions 24A and 24B. Each of the weld portions 42 is formed on one location of each of the side portions 24A and 24B. The weld portions 42 extend in a direction (in the present embodiment, the vehicle width direction W) intersecting the direction in which the groove portion 34 extends.

### (Skin Layer 51 and Core Layer 52)

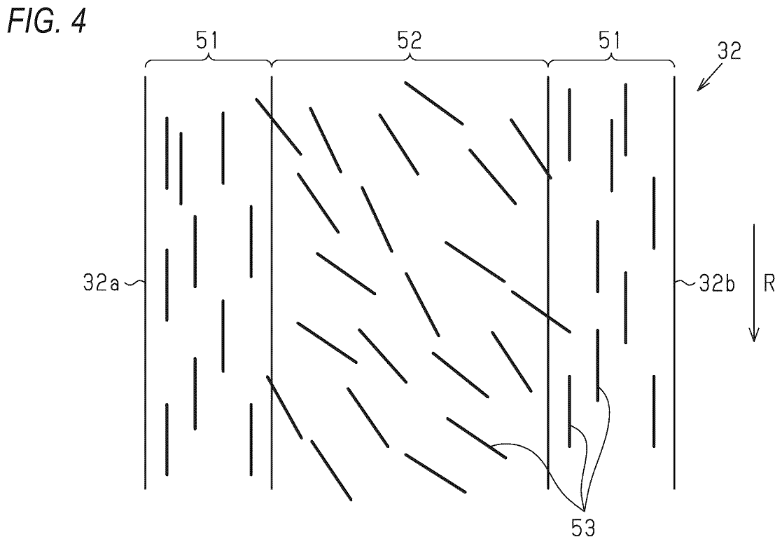

As illustrated in FIG. 4, the pair of side wall portions 31 and the bottom wall portion 32 each include a pair of skin layers 51 and a core layer 52 arranged between the pair of skin layers 51. FIG. 4 illustrates the skin layers 51 and the core layer 52 in the bottom wall portion 32.

The skin layers 51 are portions on molding surface sides that are formed by cooling and solidifying the molten resin in a cavity earlier than a central portion (the core layer 52) of the molten resin in the cavity when the front structure 22 is integrally molded by injection molding.

In the pair of skin layers 51, orientations of fibers 53 are aligned with a flow

direction R of the molten resin flowing in the cavity (in the present embodiment, the extending direction of the portions 24A, 24B, 25, and 26 of the main body portion 23) as compared with that in the core layer 52.

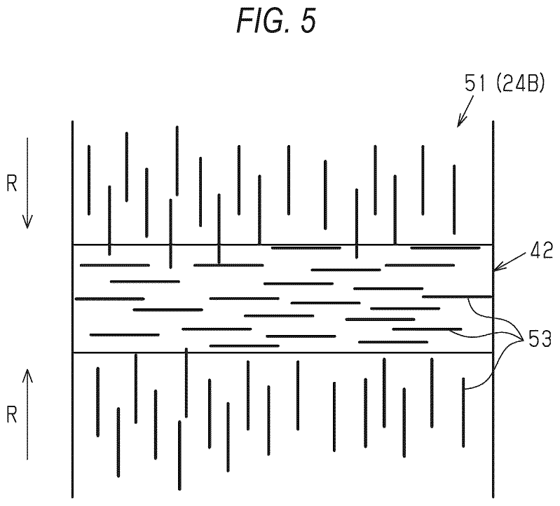

As illustrated in FIG. 5, in the skin layer 51 in the weld portion 42, orientations of the fibers 53 are aligned in a direction (in the present embodiment, the vehicle width direction W) intersecting the above-described flow direction R.

### Operations of Present Embodiment

Next, the operations of the present embodiment will be described.

When the front structure 22 is integrally molded by the injection molding, a fountain flow phenomenon, in which the molten resin bubbles up and flows toward the molding surface sides of a mold, occurs at a front end portion in the flow direction R of the molten resin flowing in the cavity of the mold. Therefore, the fibers 53 in the molten resin move along a surface of the above-described front end portion and flow toward the molding surface sides of the mold. Accordingly, as illustrated in FIG. 4, in the skin layers 51 on the molding surface sides that are formed by cooling and solidifying the molten resin filled in the cavity earlier than the central portion (the core layer 52) of the molten resin filled in the cavity, the orientations of the fibers 53 are easily aligned in the flow direction R (the extending direction of the portions 24A, 24B, 25, and 26). Since a strength of the fiber reinforced resin is increased in the direction in which the orientations of the fibers 53 are aligned, a strength of the front structure 22 is increased by the above-described skin layers 51.

Here, according to the above-described configuration, a surface area of the main body portion 23 of the front structure 22 is increased by the ridge portion 33. Accordingly, an area of the skin layers 51 is increased. As a result, the strength of the front structure 22 can be further increased.

Further, according to the above-described configuration, the end edge 26b on the lower side of the arch portion 26 constitutes a part of the outer peripheral edge 22a of the front structure 22. In other words, the front structure 22 does not include a lower portion described in WO2012/153601A1 that couples the end portions on the lower side of the pair of side portions 24A and 24B and extends in the vehicle width direction W. Even in this case, if the ridge portion 33 is formed on the main body portion 23, the strength of the front structure 22 is increased by the above-described operations, and therefore, the front structure 22 has a sufficient strength to serve as a component constituting a part of the front portion 21 of the vehicle body 20.

### Effects of Present Embodiment

Next, the effects of the present embodiment will be described.

(1) The front structure 22 includes a main body portion 23 including the pair of side portions 24A and 24B that are provided at the interval in the vehicle width direction W and extend in the upper-lower direction Z, the upper portion 25 that extends in the vehicle width direction W and couples end portions on the upper side of the pair of side portions 24A and 24B, and the pair of stay portions 26A and 26B that extend from the respective end portions on the lower side of the pair of side portions 24A and 24B in the respective directions intersecting both the vehicle width direction W and the upper-lower direction Z and are connected to the upper portion 25. The end edge 26b on the lower side of the pair of stay portions 26A and 26B constitutes a part of the outer peripheral edge 22a of the front structure 22. The pair of side portions 24A and 24B, the upper portion 25, and the pair of stay portions 26A and 26B have the ridge portion 33 serving as an uneven portion extending along the extending directions of these portions.

According to such a configuration, the above-described operations are implemented.

Therefore, the strength of the front structure 22 can be increased with a simple configuration.

(2) The ridge portion 33 serving as the uneven portion is formed continuously over all of the pair of side portions 24A and 24B, the upper portion 25, and the pair of stay portions 26A and 26B.

According to such a configuration, the area of the skin layers 51 can be increased over the entire main body portion 23. Therefore, the strength of the front structure 22 can be further increased.

(3) The main body portion 23 includes the pair of side wall portions 31 that extend in the front-rear direction X and are arranged at the interval from each other, and the bottom wall portion 32 that couples the end portions on the rear side of the pair of side wall portions 31. The ridge portion 33 serving as the uneven portion is formed on the bottom wall portion 32 and protrudes toward the front side. The groove portion 34, which extends along the ridge portion 33 and opens to the rear side, is formed on the rear surface 32b of the bottom wall portion 32.

According to such a configuration, a size of the front structure 22 in the front-rear direction X can be reduced as compared with a case in which the ridge portion 33 is a ridge portion that protrudes towards the rear side from the bottom wall portion 32 of the main body portion 23.

(4) The restricting portion 35, which extends in the direction (in the present embodiment, the upper-lower direction Z) intersecting the direction in which the groove portion 34 extends and faces the bottom surface 34a of the groove portion 34 in the front-rear direction X, is provided on the rear surface 32b of the bottom wall portion 32.

According to such a configuration, a part of the wire harness 14 routed in the front portion 11 of the automobile 10 can be accommodated in the groove portion 34. Since the wire harness 14 is surrounded in a groove portion made of a resin, a protective material such as a corrugated metal that is normally provided to protect the wire harness 14 can be eliminated.

According to the above-described configuration, the restricting portion 35, which faces the bottom surface 34a of the groove portion 34, is provided on the rear surface 32b of the bottom wall portion 32. Therefore, the wire harness 14 accommodated in the groove portion 34 is restricted from moving toward the rear side from the groove portion 34. Therefore, the wire harness 14 can be prevented from falling off from the groove portion 34.

(5) A gate mark 41, which is the mark of the gate used when the front structure 22 is

injection-molded, is formed on the main body portion 23. The gate mark 41 is formed on a portion different from the ridge portion 33.

When the front structure 22 is integrally molded by the injection molding, since the flow direction R of the molten resin flowing in the cavity is not fixed to one direction near the gate, the orientations of the fibers 53 in the skin layers 51 are difficult to be aligned in the same direction. Therefore, when the gate mark 41 is formed on the ridge portion 33, it is difficult to increase the strength by the ridge portion 33.

In this regard, according to the above-described configuration, the gate mark 41 is formed on a portion of the main body portion 23 different from the ridge portion 33. Therefore, a strength of the main body portion 23 can be suitably increased by the ridge portion 33.

(6) The main body portion 23 has the shape being symmetrical with respect to the virtual plane V that passes through the central portion of the upper portion 25 in the vehicle width direction W and is orthogonal to the vehicle width direction W. The gate mark 41 is located at the above-described central portion.

According to such a configuration, when the front structure 22 is integrally molded by the injection molding, the cavity is filled with the molten resin from the gate located at the above-described central portion. Here, the main body portion 23 of the front structure 22 has the shape that is symmetrical with respect to the virtual plane V. Therefore, the molten resin in the cavity easily flows along the certain flow direction R, such as flowing outward in the vehicle width direction W from the central portion in the cavity for molding the upper portion 25 and then flowing into the cavity for molding the side portion 24A (24B) and the stay portion 26A (26B). Accordingly, in the skin layers 51, the orientations of the fibers 53 are easily aligned in the above-described flow direction R. Therefore, the strength of the front structure 22 can be further increased.

(7) The ridge portion 33 is formed on the upper portion 25 and the pair of stay portions 26A and 26B. The main body portion 23 has the weld portion 42 formed by molten resins colliding with each other when the front structure 22 is integrally molded by the injection molding. The weld portion 42 is formed only on the pair of side portions 24A and 24B.

Since the upper portion 25 and the pair of stay portions 26A and 26B each have a component extending in the vehicle width direction W, a load in the vehicle width direction W is likely to act on the upper portion 25 and the pair of stay portions 26A and 26B when the vehicle body 20 is twisted during turning or the like of the automobile 10. Therefore, the upper portion 25 and the stay portions 26A and 26B are each required to have a strength capable of withstanding the above-described load.

Meanwhile, when the front structure 22 is integrally molded by the injection molding, the weld portion 42 is formed on the front structure 22 by the molten resins branched in the cavity colliding with each other. In the weld portion 42, orientation directions of the fibers 53 are changed by changing the flow direction R (in the present embodiment, the upper-lower direction Z, which is the direction in which the side portions 24a and 24B extend) due to the collision. Therefore, as illustrated in FIG. 5, the fibers 53 are oriented in the direction (in the present embodiment, the vehicle width direction W) intersecting the flow direction R of the molten resin flowing in the cavity. Accordingly, a strength of the weld portion 42 is likely to be lower than that of other portions.

In this regard, according to the above-described configuration, the weld portions 42 is formed only on the pair of side portions 24A and 24B. Therefore, the strength of the upper portion 25 and the pair of stay portions 26A and 26B is not reduced by the weld portion 42. Further, since the ridge portion 33 is formed on the upper portion 25 and the pair of stay portions 26A and 26B, the strength of the upper portion 25 and the pair of stay portions 26A and 26B is increased by the ridge portion 33.

Therefore, the strength of the front structure 22 can be further increased.

### Modifications

The present embodiment can be modified and implemented as follows. The present embodiment and the following modifications can be combined with each other and implemented without technical contradiction.

The front structure 22 is not limited to the one in which the gate mark 41 is formed at a position exemplified in the present embodiment, and the arrangement and the number of the gate marks 41 may be appropriately changed as long as the weld portion 42 is formed only on the pair of side portions 24A and 24B. For example, in the front structure 22, the plurality of gate marks 41 may be arranged at intervals from each other along the direction in which the portions of the main body portion 23 extend.

The front structure 22 is not limited to the one in which the weld portions 42 is formed only on the pair of side portions 24A and 24B as exemplified in the present embodiment, and the weld portion 42 may be formed on the upper portion 25 or the arch portion 26. According to such a configuration, when the front structure 22 is integrally molded by the injection molding, a degree of freedom in forming the gate is improved.

In the front structure 22, the gate mark 41 may be located on the ridge portion 33.

The present embodiment exemplifies the one in which the pair of stay portions 26A and 26B, as a whole, constitute the arch portion 26, but the pair of stay portions 26A and 26B may be provided independently of each other. More specifically, the stay portion 26A and the stay portion 26B are not limited to being connected to the upper portion 25 at the central portion of the upper portion 25 in the vehicle width direction W, and may be connected to the upper portion 25 at positions separated from each other in the vehicle width direction W. In this case, it is sufficient that the ridge portions 33 formed on the pair of stay portions 26A and 26B are connected to the ridge portion 33 formed on the upper portion 25.

The main body portion 23 is not limited to having the shape that is symmetrical with respect to the virtual plane V, and may have a shape that is asymmetrical with respect to the virtual plane V as long as the main body portion 23 includes the pair of side portions 24A and 24B, the upper portion 25, and the pair of stay portions 26A and 26B.

The arrangement and the number of the restricting portions 35 are not limited to those exemplified in the present embodiment, and may be appropriately changed according to types, the number, positions, and the like of the elongated members routed in the groove portion 34. For example, the restricting portion 35 may be provided on each of the pair of side portions 24A and 24B or each of the pair of stay portions 26A and 26B. The number of the restricting portions 35 may be one, or may be three or more. Further, the restricting portion 35 may be omitted.

The front structure 22 is not limited to the one in which the ridge portion 33 is formed only on the bottom wall portion 32 as exemplified in the present embodiment, and for example, the ridge portion 33 may be formed on at least one of the pair of side wall portions 31.

The ridge portion 33 may not extend continuously over the entire main body portion 23. That is, in the front structure 22, a plurality of ridge portions 33 may be arranged at intervals along the direction in which the portions 24A, 24B, 25, 26A, and 26B of the main body portion 23 extend.

The ridge portion 33 is not limited to being formed on all portions of the pair of side portions 24A and 24B, the upper portion 25, and the pair of stay portions 26A and 26B as exemplified in the present embodiment. That is, in the front structure 22, it is sufficient that the ridge portion 33 is formed on at least one of the side portion 24A, the side portion 24B, the upper portion 25, the stay portion 26A, and the stay portion 26B.

The uneven portion according to the present invention is not limited to the ridge portion 33 exemplified in the present embodiment. For example, the uneven portion may be a ridge portion that protrudes towards the rear side from the rear surface 32b of the bottom wall portion 32. In this case, a groove portion, which extends along the above-described ridge portion and opens to the front side, is formed on a front surface 32a of the bottom wall portion 32.

The front structure 22 may support the headlights 12 and the exterior member 13, or may be disposed in the front side of a radiator to support the radiator.

The upper portion 25 of the front structure 22 may be provided with a hood lock.

The front structure according to the present invention is not limited to the front structure 22 of the automobile 10, and the present invention can be applied to any front structure that constitutes a part of a front portion of a vehicle body in a vehicle.

What is claimed is:

1. A front structure of a vehicle, which is made of a fiber reinforced resin and integrally molded by injection molding,
the front structure constituting a part of a front portion of a vehicle body of the vehicle, and comprising a main body portion that includes:
when a width direction and an upper-lower direction of the vehicle are referred to as a vehicle width direction and an upper-lower direction, and an upper side and a lower side in the upper-lower direction are simply referred to as an upper side and a lower side,
a pair of side portions that are provided at an interval in the vehicle width direction, and extend in the upper-lower direction;
an upper portion that extends in the vehicle width direction, and couples end portions on the upper side of the pair of side portions; and
a pair of stay portions that extend from respective end portions on the lower side of the pair of side portions in respective directions intersecting both the vehicle width direction and the upper-lower direction, and are connected to the upper portion,
wherein an end edge on the lower side of the pair of stay portions constitutes a part of an outer peripheral edge of the front structure, and
at least one of the side portions, the upper portion, or the stay portions has an uneven portion extending along a direction in which the portion extends.

2. The front structure according to claim 1,
wherein the uneven portion is provided continuously over all of the pair of side portions, the upper portion, and the pair of stay portions.

3. The front structure according to claims 1,
wherein when a front-rear direction of the vehicle is referred to as a front-rear direction, and a front side and a rear side in the front-rear direction are simply referred to as a front side and a rear side,
the main body portion includes:
a pair of side wall portions that extend in the front-rear direction, and are arranged at an interval from each other; and
a bottom wall portion that couples end portions on the rear side of the pair of side wall portions,
the uneven portion is a ridge portion provided on the bottom wall portion and protruding toward the front side, and
a groove portion is provided on a rear surface of the bottom wall portion, the groove portion extending along the ridge portion and opening to the rear side.

4. The front structure according to claim 3,
wherein a restricting portion is provided on the rear surface of the bottom wall portion, the restricting portion extending in a direction intersecting a direction in which the groove portion extends and facing a bottom surface of the groove portion.

5. The front structure according to claim 1,
wherein a gate mark is formed on the main body portion, the gate mark being a mark of a gate used when the front structure is injection-molded, and
the gate mark is formed on a portion different from the uneven portion.

6. The front structure according to claim 5,
wherein the main body portion has a shape being symmetrical with respect to a virtual plane that passes through a central portion of the upper portion in the vehicle width direction and is orthogonal to the vehicle width direction, and
the gate mark is located at the central portion.

7. The front structure according to claim 6,
wherein the uneven portion is provided on the upper portion and the pair of stay portions,
the main body portion has a weld portion formed by molten resins colliding with each other when the front structure is integrally molded by the injection molding, and
the weld portion is formed only on the side portion.
